(19) United States
(12) Patent Application Publication
(10) Pub. No.: US 2026/0168238 A1
(43) Pub. Date: Jun. 18, 2026

(54) SYSTEM FOR PASSIVELY RECHARGING A VACUUM INSULATION PANEL

(71) Applicant: CARLISLE CONSTRUCTION MATERIALS, LLC, Carlisle, PA (US)

(72) Inventors: Benjamin McFADDEN, Gettysburg, PA (US); Gregory MOUNTAIN, Newville, PA (US)

(73) Assignee: CARLISLE CONSTRUCTION MATERIALS, LLC, Carlisle, PA (US)

(21) Appl. No.: 19/391,177

(22) Filed: Nov. 17, 2025

Related U.S. Application Data
(60) Provisional application No. 63/734,716, filed on Dec. 16, 2024.

(51) Int. Cl. E04B 1/80; F16L 59/065; G05D 16/04

(52) U.S. Cl. CPC E04B 1/803; F16L 59/065; G05D 16/04

(57) ABSTRACT

A system for passively recharging a vacuum insulated panel, including: (a) a vacuum insulated panel having a one-way air valve in an air-tight covering; (b) an air passageway connected to the one-way air valve; and (c) an air pressure reduction system connected to the air passageway, wherein the air pressure reduction system provides a reduced air pressure when wind flow over the air pressure reduction system.

### RELATED APPLICATION

The present application claims priority to U.S. Provisional Patent Application Ser. No. 63/734,716, of same title, filed Dec. 16, 2024, the entire disclosure of which is incorporated herein by reference in its entirety for all purposes.

### TECHNICAL FIELD

The present invention relates to systems for extending the lifespan of Vacuum Insulation Panels.

### BACKGROUND OF THE INVENTION

Vacuum Insulation Panels (VIPs) are panels that provide thermal insulation. They typically comprise a center core portion made from a rigid, highly-porous material such as fumed silica, aerogel, perlite, or glass fiber. The center core is surrounded by a gas-tight membrane material. When they are manufactured, air is evacuated from the interior of the panel, and the gas tight material is then sealed to keep a vacuum or near vacuum on the inside. The gas-tight membrane prevents air from entering into the center core of the panel.

Due to the vacuum or near vacuum conditions inside the panel, the panel provides excellent insulation properties. In addition, the manufacturing process of evacuating the air from the center portion of the panel causes the center material in the panel to compress. The result is that the assembled panel shrinks somewhat in depth. Accordingly, what is provided is a very thin panel having excellent insulation properties. Due to being very thin, VIPs are ideal for situations where there is limited space. VIPs have been used in building construction, refrigeration units, and insulated shipping containers to provide better insulation performance than conventional insulation materials.

One example of a VIP is the OPTIM-R® VIP sold by Carlisle Construction Materials of Carlisle, Pennsylvania. OPTIM-R® provides an R-value that is up to five times the R-value of commonly used insulation products. Specifically, OPTIM-R® has been shown to provide an R-38 insulating value in a 2.6″ system thickness with up to 35% infill (non-VIP material). OPTIM-R® has proven to be an ideal solution for adding R-value where height restrictions exist (e.g. penthouse doors opening onto rooftop, windows near roof line, through-wall scuppers, equipment curbs needing to be raised, parapet wall modifications, etc.).

Unfortunately, VIPs are expensive to make, and their adoption as building insulation has been somewhat limited. Another problem with VIPs is that they cease to work if punctured. This is because any puncture will simply permit air to enter the panel, thereby destroying or severely compromising its insulation ability. This limitation is especially problematic in building roofing as roofing components and membranes are often mechanically fastened to one another. Mechanical fasteners simply can't be allowed to pass through the VIPs.

In order to adequately protect the OPTIM-R® panels against punctures, Carlisle recommends that their ½″ SecurShield® HD insulating cover board be installed above and below the OPTIM-R®. The base layer of SecurShield® HD may be adhered or mechanically fastened to the roof deck, with additional layers of insulation adhered using Carlisle's Flexible FAST™ Adhesive.

Another related limitation with using VIPs in building roofing is that they can't be cut or trimmed to fit into particular areas. In contrast, traditional insulation materials and systems are simply cut to fit into oddly shaped areas on the building roof. As such, VIPs in non-standard sizes must be made to order, which also increases their cost. To date, high cost and the above construction limitations have generally kept VIPs out of many traditional housing situations. However, their very low thermal conductivity makes them useful in situations where either strict insulation requirements or space constraints make traditional insulation impractical.

A final concern is that VIPs tend to lose their vacuum over time. As such, their effective lifespan is typically shorter than with conventional building insulation. To increase the lifespan of VIPs, the gas-tight membrane must be highly engineered, tough and durable. Strict quality control of manufacture of the membranes and sealing joints is important if a panel is to maintain its vacuum over a long period of time. Unfortunately, air will gradually enter the panel, and as the pressure of the panel normalizes with the surrounding air, its R-value deteriorates. Increasing the membrane's strength and longevity incurs additional costs. In contrast, conventional insulation does not depend on the evacuation of air for its thermal performance, and is therefore not susceptible to this form of deterioration.

What is instead desired is a system for keeping VIPs operational for extended periods of time. Such a system would help the VIP maintain its vacuum for a longer period of time. This would increase the lifespan of the VIP and make it a more commercially desirable option as compared to traditional insulation.

### SUMMARY OF THE INVENTION

In preferred aspects, the present system provides a system for passively recharging vacuum insulated panels. The present system comprises a vacuum insulated panel and an air pressure reduction system connected together by an air passageway. The vacuum insulated panel (VIP) comprises: a center core insulation material, an air-tight covering wrapped around the center core insulation material, wherein the air-tight covering seals a lower air pressure area inside the covering from a higher ambient air pressure area outside the air-tight covering; and a one-way air valve in the air-tight covering. The air pressure reduction system is a passive system that provides a reduced air pressure when wind flows over it. An air passageway connects the one-way air valve in the vacuum insulated panel to the passive air pressure reduction system.

When the wind blows across the surface of the pressure reduction system, it sucks air out through the air passageway which in turn sucks air out through the one-way valve in the vacuum insulated panel. In the case of multiple VIPs, they can all be connected through a manifold of air pressure passageways to a single pressure reduction system. In this embodiment, one pressure reduction system may be used to suck air out (a.k.a. “recharge”) a number of separate VIPs.

The present system operates intermittently when the wind is flowing over it. Higher wind speeds will exert greater suction on the VIPs and lower wind speeds will exert lower pressures on the VIPs. One important advantage of the present system is its passive nature. Its intermittent operation is not a problem because operation of the present system at any time will extend the lifespans of the VIPs. A second advantage of the present system is that it requires no cost to operate. It does not require vacuum pumping equipment, or any control system to manage operation of a vacuum pump. The present system has no moving parts and requires no energy (other than the passage of wind over it) to operate.

In preferred aspects, the present air pressure reduction system is mounted on top of a building, and the air passageway extends between the one-way air valve and the air pressure reduction system by passing underneath of a roofing membrane. The air present air pressure reduction system may be a passive vacuum generator and may preferably have a venturi system connected to an end of the air passageway.

In other preferred aspects, the present air pressure reduction system is mounted on the side of a building (such as a downtown office or residential tower) to take advantage of wind flows and wind tunnel effects that occur between tall buildings in dense urban environments. In addition, it is to be understood that the present system can be used to provide insulation in building walls as well as in building roofs, as desired.

### BRIEF DESCRIPTION OF THE DRAWINGS

FIG. 1 is an illustration of a VIP installed on a roof in the absence of the present air pressure reduction system.

FIG. 2 is a side elevation view of the present system in use with a rooftop vent system acting as the air pressure reduction system.

FIG. 3A is a side elevation view of a simple venturi system acting as the air pressure reduction system.

FIG. 3B is a close-up perspective view of the venture of FIG. 3A.

FIG. 4A is a perspective view of a manifold for attachment to four VIPs.

FIG. 4B is a close-up perspective view of one of the nozzles on the bottom of the manifold.

FIG. 4C is a top plan view of the manifold of FIG. 4A connected to four VIPs.

### DETAILED DESCRIPTION OF THE DRAWINGS

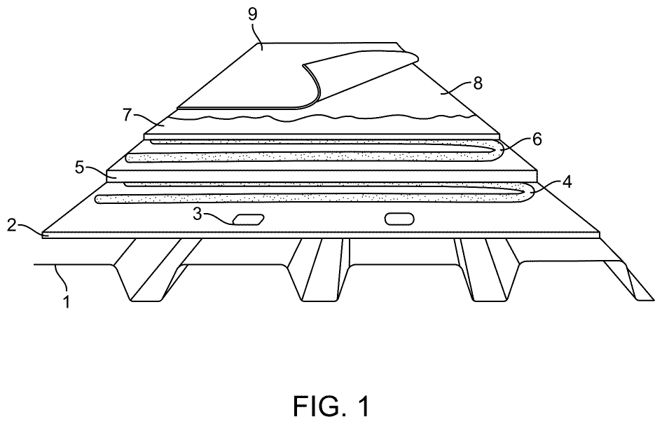

FIG. 1 is an illustration of an OPTIM-R® VIP sold by Carlisle Construction Materials of Carlisle, Pennsylvania installed on a roof. As can be seen, the VIP (labelled 5) is installed between two ½″ SecurShield® HD insulating cover boards (labelled 2 and 7) for protection. Adhesive layers (labelled 4 and 6) secure the structure together. A roofing membrane (labelled 9) is then adhered thereover. The base layer (2) of SecurShield® HD coverboard may be adhered or mechanically fastened to the roof deck (1).

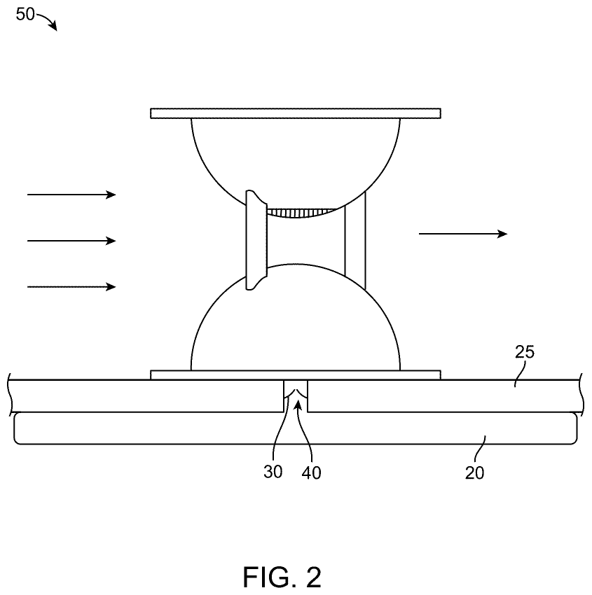

FIG. 2 is an illustration of the present system in use with a rooftop vent system acting as the air pressure reduction system. In this system for passively recharging a vacuum insulated panel, the following components are installed. First, a vacuum insulated panel 20, comprising a center core insulation material and an air-tight covering wrapped around the center core insulation material is provided. The air-tight covering seals a lower air pressure area inside the covering from a higher ambient air pressure area outside the air-tight covering. Preferably, the lower pressure area in the vacuum insulated panel 20 is a vacuum or near vacuum. Also provided is a one-way air valve 30 in the air-tight covering. An air passageway 40 connects the one-way air valve 30 to the air pressure reduction system 50. A roofing membrane 25 is placed over VIP 20. It is to be understood that optional embodiments of the present system can be used in building walls as well as on building roofs.

Air pressure reduction system 50 provides a reduced air pressure when wind flow over the air pressure reduction system. An ideal pressure reduction system 50 is found in U.S. Pat. No. 7,607,974, entitled Rooftop Vent for Reducing Pressure Under a Membrane Roof, owned by Carlisle Construction Materials of Carlisle, Pennsylvania, or U.S. Pat. No. 10,889,989, entitled Roof Monitoring System, both incorporated herein by reference for all purposes. This roof vent system has two opposed convex domes separated by a gap. Wind blowing across the roof flows between the domes where it accelerates and creates a region of low pressure according to the Venturi effect. The lower dome has an opening at the gap so that the low pressure can be applied to the space under the membrane roof. Therefore, when wind blows across the roof, the vent normally draws air from under the membrane and the membrane is pressed against the roof, preventing liftoff. In accordance with the present invention, however, this roof vent is instead used to exert suction on one-way air valve 30 to pull air out of VIP 20, and thereby “recharge” the VIP. Such force will be highest at high wind speeds, but any instances of a suction force being exerted on one-way air valve 30 will be beneficial to VIP 20 and extend its effective lifespan. As can be seen, air pressure reduction system 50 is mounted on top of a building, and the air passageway 40 between the one-way air valve 30 and the air pressure reduction system 30 passes underneath a roofing membrane 25. In optional embodiments, the air pressure reduction system can be mounted to exterior sides of a building and that the VIP insulation can be used in building walls instead of, or in addition to, a building roof. In further optional embodiments, the air pressure reduction system can be mounted onto the side of a building, and connected to VIP insulation on a building roof. All these embodiments are contemplated within the scope of the present invention.

Being a passive vacuum system has many advantages. For example, U.S. Published Patent Application 20210010629, entitled Vacuum Soundproofing/Insulating Panels with Vacuum Pump Connector Assembly and Method and System for Using Same to Provide Adjustable Insulative Efficiency to a Building Envelope discloses a system for using a digitally controlled vacuum pump to continuously vary the vacuum in several VIPs in a building so as to change the heating and cooling efficiency of the building. Unfortunately, this system requires complex control systems and specifically uses vacuum pumps that are turned on and off. As such, it has operating costs and energy needs. In contrast, the present system is free to operate and requires no control system.

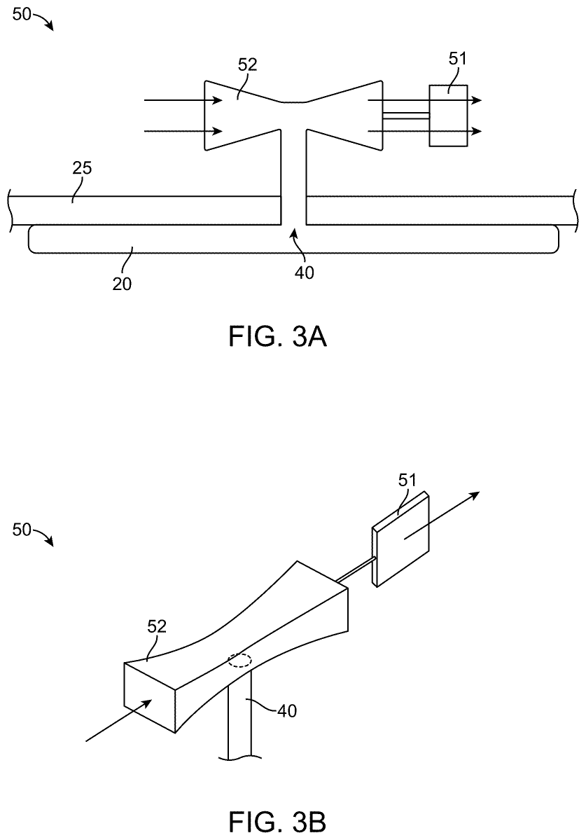

Although the present system is ideally suited to work with the Rooftop Vent system described in U.S. Pat. Nos. 7,607,974, and 10,889,989, it is by no means so limited. For example, as seen in FIGS. 3A and 3B, other systems for reducing air pressure are also contemplated, all keeping within the scope of the present invention. In this system the venturi 52 acting air pressure reduction system 50. Venturi 52 is freely rotatable and has a vane 53 for pointing it into the wind. Other roof mounted air pressure reduction systems can also be used, all keeping within the scope of the present invention.

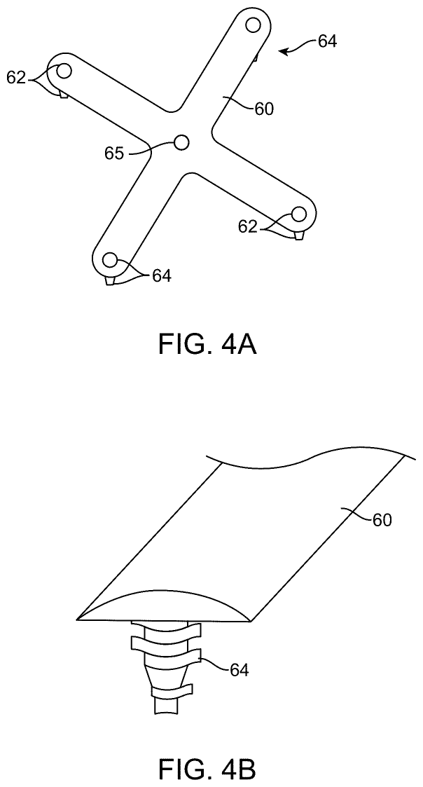

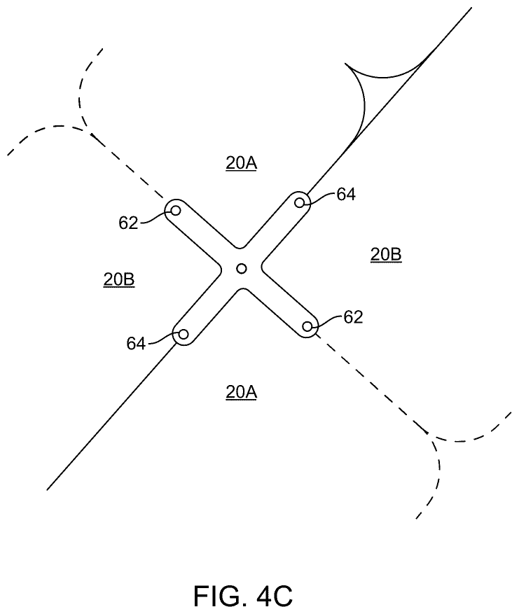

FIGS. 4A to 4C illustrates a manifold system in which a single air pressure reduction system is connected to a plurality of VIPs, as follows.

FIG. 4A is a perspective view of a manifold 60 for attachment to four VIPs. Manifold 60 is hollow and has four nozzles 62 and 64. In this particular embodiment, nozzles 62 are shorter and nozzles 64 are slightly longer, as will be explained. Also provided is an aperture or connection 65 for connection to a single air pressure reduction system 50 (not shown). FIG. 4B is a close-up perspective view of one of the nozzles 64 on the bottom of the manifold. FIG. 4C is a top plan view of the manifold of FIG. 4A connected to four VIPs. Specifically, as seen in FIG. 4C, an upper layer of two VIPs 20A sit on top of a lower layer of two VIPs 20B. (Only a representative portion of the entire roofing system is illustrated). In operation, shorter nozzles 62 are projected into upper VIPs 20A. The longer nozzles 64 are positioned safely between the side edges of upper VIPs 20A, but project down into lower VIPs 20B. Specifically, nozzles 62 and 64 are punctured down into the VIPs, forming a vacuum tight seal with a gasket (not shown). Preferably, manifold 60 has a curved upper surface as shown such that it will not puncture or cause wear on the roofing membrane placed thereover. FIG. 4C illustrates a single manifold providing a vacuum to four VIPs stacked in two layers. However, in the case of a single layer of VIPs, a three-arm version of manifold 60 could be used to simultaneously provide air pressure reduction to three VIPs. It is to be understood that the present invention encompasses any manifold that provides air pressure reduction to two or more VIPs.

What is claimed is:

1. A system for passively recharging a vacuum insulated panel, comprising:
a vacuum insulated panel, comprising:
a center core insulation material,
an air-tight covering wrapped around the center core insulation material, wherein the air-tight covering seals a lower air pressure area inside the covering from a higher ambient air pressure area outside the air-tight covering, and
a one-way air valve in the air-tight covering;
an air passageway connected to the one-way air valve; and
an air pressure reduction system connected to the air passageway, wherein the air pressure reduction system provides a reduced air pressure when wind flow over the air pressure reduction system.

2. The system of claim 1, wherein the air pressure reduction system is mounted on top of a building, or on the side of a building.

3. The system of claim 2, wherein the air passageway between the one-way air valve and the air pressure reduction system passes underneath a roofing membrane.

4. The system of claim 1, wherein the air pressure reduction system comprises a venturi system connected to an end of the air passageway.

5. The system of claim 1, wherein the air pressure reduction system is a passive vacuum generator.

6. The system of claim 1, wherein the air pressure reduction system is a rooftop vent system for reducing air pressure below a roofing membrane.

7. The system of claim 1, wherein the lower pressure area in the vacuum insulated panel is a vacuum or near vacuum.

8. The system of claim 1, wherein the air passageway further comprises:
a manifold system connecting the air pressure reduction system to a plurality of different vacuum insulated panels.

9. A system for passively recharging a vacuum insulated panel, comprising:
a plurality of vacuum insulated panels, each vacuum insulated panel comprising:
a center core insulation material, and
an air-tight covering wrapped around the center core insulation material, wherein the air-tight covering seals a lower air pressure area inside the covering from a higher ambient air pressure area outside the air-tight covering;
a one-way air valve in the air-tight covering;
an air pressure reduction system, wherein the air pressure reduction system provides a reduced air pressure when wind flow over the air pressure reduction system; and
a manifold of air passageways, wherein the air passageways are connected from the air pressure reduction system to each of the plurality of vacuum insulated panels.

10. The system of claim 9, wherein the air pressure reduction system is mounted on top of a building or onto the side of a building.

11. The system of claim 9, wherein the manifold passes underneath a roofing membrane.

12. The system of claim 9, wherein the air pressure reduction system comprises a venturi system connected to an end of the air passageway.

13. The system of claim 9, wherein the air pressure reduction system is a passive vacuum generator.

14. The system of claim 9, wherein the air pressure reduction system is a rooftop vent system for reducing air pressure below a roofing membrane.
